(19) United States
(12) Patent Application Publication
(10) Pub. No.: US 2026/0159408 A1
(43) Pub. Date: Jun. 11, 2026

(54) Cerium-Gadolinium Composite Oxide

(71) Applicant: Rhodia Operations, Lyon (FR)

(72) Inventors: Eisaku Suda, Toushima city, Tokushima (JP); Takuma Okamoto, Anan-city, Tokushima (JP); Naotaka Ohtake, Anan-city, Tokushima (JP); Tetsuya Shozui, Anan-city, Tokushima (JP); Camille Jourde, Paris (FR)

(21) Appl. No.: 18/707,939

(22) PCT Filed: Nov. 2, 2022
(86) PCT No.: PCT/EP2022/080567

§ 371 Date: May 7, 2024

(30) Foreign Application Priority Data
Nov. 8, 2021 (EP) 21315238.2

(51) Int. Cl. C01F 17/241; C04B 35/50; C04B 35/626; C04B 35/63; C04B 35/64; C25B 11/047; H01M 4/86; H01M 8/126

(52) U.S. Cl. CPC C01F 17/241; C04B 35/50; C04B 35/6262; C04B 35/6303; C04B 35/64; C25B 11/047; H01M 4/8621; H01M 8/126; C01P 2002/50; C01P 2002/72; C01P 2004/53; C01P 2004/61; C01P 2004/62; C01P 2006/10; C01P 2006/11; C01P 2006/12; C01P 2006/14; C01P 2006/17; C01P 2006/40; C04B 2235/3229; C04B 2235/443; C04B 2235/656

(57) ABSTRACT

The invention relates to a composite oxide based on cerium and gadolinium with a proportion of Gd between 8 and 22 mol %, this proportion corresponding to the molar ratio Gd/(Ce+Gd) expressed in %, which exhibits an improved relative density.

### CROSS-REFERENCE TO RELATED APPLICATIONS

This application is the United States national phase of International Patent Application No. PCT/EP2022/080567 filed Nov. 2, 2022, and claims priority to European Patent Application No. 21315238.2 filed Nov. 8, 2021, the disclosures of which are hereby incorporated by reference in their entireties.

### BACKGROUND OF THE INVENTION

### Field of the Invention

The present invention relates to a cerium-gadolinium composite oxide, the method of preparation thereof and the use thereof. The invention also relates to a SOFC or a SOEC containing the composite oxide of the invention.

A solid oxide fuel cell (or SOFC) is an electrochemical conversion device that produces electricity directly from oxidizing a fuel. It is an electrochemical device for the generation of electrical energy through the electrochemical oxidation of a fuel gas (usually hydrogen based). The device is ceramic-based, and uses an oxygen-ion conducting metal-oxide derived ceramic as its electrolyte. As ceramic oxygen ion conductors known in the art (most typically doped zirconium oxide or doped cerium oxide) only demonstrate technologically relevant ion conductivities at temperatures in excess of 500° C. (for cerium-oxide based electrolytes) or 600° C. (for zirconium oxide based ceramics), all SOFCs have to operate at elevated temperatures.

The electrolyte is an essential part of the cell, and has the following main functions in an SOFC:
allowing the passage of electric current between the cathode (positive air electrode) and anode (negative fuel electrode) in the form of mobile oxygen ions;
blocking the passage of electric current between the electrodes in the form of electrons which would cause an internal short circuit within the cell
preventing the mixing of fuel and air, meaning the electrolyte needs to be at least 94% of theoretical density so there is no interconnecting porosity and hence the electrolyte layer is gas impermeable, and substantially free of defects.

As disclosed in US 2016/233534, recent developments in the field of SOFC have led to the use of a cerium-gadolinium composite of formula Ce_{0.9}Gd_{0.1}O_{1.95} as the oxygen ion conducting electrolyte, having an intrinsically higher oxygen ion conductivity than zirconia-based materials.

### Description of Related Art

EP 1484282 B1 discloses a cerium-gadolinium composite oxide for which high relative densities are obtained at high processing temperatures. There is no disclosure of the same composite oxide as in the invention.

U.S. Pat. No. 6,709,628 discloses a process for production of a sintered oxide ceramic based on cerium, a first doping element selected from the group consisting of Lu, Yb, Tm, Er, Y, Ho, Dy, Gd, Eu, Sm and Nd and a second doping element selected from the group consisting of Cu, Co, Fe, Ni, and Mn, involving a sintering step at a temperature between 750° C. and 1200° C. so as to reach a density of at least around 98% of the theoretically possible density. Without the second dopant, the density is only 90% at 1450° C. Specific compositions such as Ce_{0.8}Gd_{0.2}Co_{z}O₂₋ₐ or Ce_{0.8}Gd_{0.2} Cu_{z}O₂₋ₐ are disclosed.

US 2016/0233535 discloses a process for forming an electrolyte for a metal-supported solid-oxide fuel cell (SOFC) comprising the step of combining a doped-ceria electrolyte such as Ce_{0.9}Gd_{0.1}O_{1.95} or Ce_{0.9}Sm_{0.1}O_{1.95} with a sintering aid. As is visible on FIG. 9, the relative density of the doped-ceria electrolyte with no sintering aid (e.g. Co₃O₄ or CuO) is lower than 94% after calcination at 1100° C., which means that it would be even lower at a lower temperature.

U.S. Pat. No. 7,947,212 B2 discloses densification of a ceria-based electrolyte through the use of divalent or trivalent cations. Without any cation, the relative density is lower than 94% (FIG. 2).

JP-A-2000/007435 discloses a composite oxide based on ceria which can be used in the preparation of a SOFC. The composite oxide is prepared by a process which is different from the process of the invention. Moreover, high densities are obtained but at a temperature higher than 1500° C.

The article of Duran et al. “Sintering and microstructural development of ceria-gadolinia dispersed powders”, J. Mat. Sci. 1994, 29 (7) discloses composite oxide ceria-gadolinia with a proportion of Gd lower than as described herein and that exhibiting a relative density at temperatures higher than 1300° C.

The article Journal of Physics: Conference Series 339 (2012) 012006 (doi: 10.1088/1742-6596/339/1/012006) discloses the relative densities of a 10 mol % gadolinium-doped ceria. The relative densities are lower than the ones of the composition of the invention.

### SUMMARY OF THE INVENTION

The process of densification of the electrolyte requires sintering at a high temperature. It is also advantageous to reach a high relative density to ensure the preparation of an air tight and robust electrolyte in order to avoid contact between the fuel gas and the oxidizing gas (see Journal of The Electrochemical Society 2002, 149 (7), A797-A803).

It is of course more advantageous to reach the high relative density at the lowest temperature in order to save energy. It is also desirable to sinter at the lowest temperature to avoid deterioration such as oxidation or sintering of the other components used in the preparation of the SOFC.

Finally, as the electrolyte is in contact with gases at high temperatures, it is also necessary that it withstands the harsh conditions encountered.

It has been found that the composite oxide of the invention can reach a high relative density at a high temperature such as 950° C. even without adding or incorporating any sintering agent. This makes it possible to avoid the introduction of further elements that may have an impact on the final physicochemical properties of the inorganic layer of the fuel cell that contains the composite oxide.

The invention thus aims at preparing a ceria-based electrolyte suitable for the production of a SOFC which can be sintered at a high relative density at a high temperature such as 950° C. even without adding any sintering agent.

The invention relates to composite oxide based on cerium and gadolinium with a proportion of Gd between 8.0 and 22.0 mol %, this proportion corresponding to the molar ratio Gd/(Ce+Gd) expressed in %.

The composite oxide of the invention is disclosed herein. The invention also relates to a composition C as disclosed herein.

The invention also relates to the process of preparation of the composite oxide as disclosed herein, to the use of the composite oxide or composition C as disclosed herein. The invention also relates to a SOFC as disclosed herein. The invention also relates to a SOEC as disclosed herein.

All these objects are defined in more details below.

### BRIEF DESCRIPTION OF THE DRAWINGS

FIG. 1 and FIG. 2 represent distribution of size of the composite oxides disclosed in the examples and obtained with a laser diffraction.

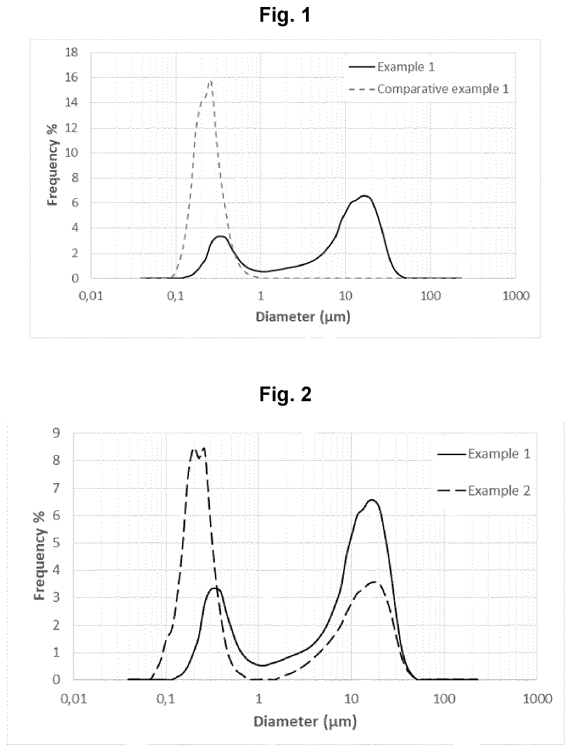

FIG. 3 represents a program obtained by Hg porosimetry of the composite oxide of example 1.

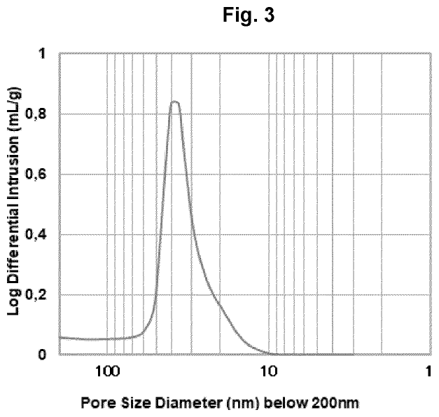

### DESCRIPTION OF THE INVENTION

It is pointed out that in the rest of the description, unless otherwise indicated, in the ranges of values given, the upper and/or lower limits are included.

The composite oxide of the invention is based on cerium oxide and gadolinium oxide. It is characterized by a proportion of Gd between 8.0 mol % and 22.0 mol %, this proportion corresponding to the molar ratio Gd/(Ce+Gd) expressed in %.

The proportion of Ce corresponds to the complement to 100%. The proportion of Ce is between 78.0 mol % and 92.0 mol %.

The proportion of Gd may be more particularly between 8.0 mol % and 15.0 mol %. In that case, the proportion of Ce is between 85.0 mol % and 92.0 mol %.

The proportion of Gd may be more particularly between 8.0 mol % and 12.0 mol %. In that case, the proportion of Ce is between 88.0 mol % and 92.0 mol %.

The proportion of Gd may be more particularly between 9.0 mol % and 11.0 mol %. In that case, the proportion of Ce is between 89.0 mol % and 91.0 mol %.

The proportion of Gd may be more particularly between 9.5 mol % and 10.5 mol %. In that case, the proportion of Ce is between 89.5 mol % and 90.5 mol %.

The proportion of Gd may be more particularly between 18.0 mol % and 22.0 mol %. In that case, the proportion of Ce is between 78.0 mol % and 82.0 mol %.

The proportion of Gd may be more particularly between 19.0 mol % and 21.0 mol %. In that case, the proportion of Ce is between 79.0 mol % and 81.0 mol %.

The proportion of Gd may be more particularly between 19.5 mol % and 20.5 mol %. In that case, the proportion of Ce is between 79.5 mol % and 80.5 mol %.

The invention also relates to a composite oxide consisting of the two oxides CeO₂ and Gd₂O₃, notably according to the proportions given above.

According to an embodiment, the X-ray diffractogram (CuKα1, λ=1.5406 Angstrom) of the composite oxide exhibits the patterns of a solid solution. According to another embodiment, the X-ray diffractogram of the composite oxide exhibits a peak P at 2θ between 27.0 and 30.0°. This peak P is of the highest intensity on the diffractogram.

The composite of the invention comprises the above mentioned elements (Ce, Gd) with the above mentioned proportions but it may also additionally comprise impurities. The impurities may stem from the raw materials or starting materials used in the process of preparation of the composite oxide. The total proportion of the impurities is lower than 0.20 wt %, preferably lower than 0.10 wt %, preferably even lower than 0.05 wt %, with respect to the composite oxide. All what is disclosed herein applies to the composite oxide consisting of CeO₂ and of Gd₂O₃ with the proportions given above and of the impurities, the total proportion of which being lower than 0.20 wt %, preferably lower than 0.10 wt %, even preferably lower than 0.05 wt %.

The composite of the invention exhibits certain physicochemical characteristics that are provided below:

### 1) Relative Densities RD

The composite oxide may exhibit a relative density RD_{1000° C./5 h} of at least 95.0% after calcination at 1000° C. for 5 hours. RD_{1000° C./5 h} is preferably at least 96.0%. RD_{1000° C./5 h} may be at most 99.0% or at most 98.0%. RD_{1000° C./5 h} may be between 96.0% and 99.0%, more particularly between 96.0% and 98.0%.

The composite oxide may exhibit a relative density RD_{950° C./5 h} of at least 94.0% after calcination at 950° C. for 5 hours. RD_{950° C./5 h} is preferably at least 95.0%. RD_{950° C./5 h} may be at most 98.0% or at most 97.0%. RD_{950° C./5 h} may be between 94.0% and 98.0%, more particularly between 95.0% and 97.0%.

The composite oxide may exhibit a relative density RD_{1100° C./5 h} of at least 99.0%, preferably at least 99.5%, after calcination at 1100° C. for 5 hours. RD_{1100° C./5 h} may be at most 99.0% or at most 99.5%. RD_{1100° C./5 h} may be between 99.0% and 100.0%, more particularly between 99.5% and 99.9%.

The composite oxide may exhibit a relative density RD_{1200° C./5 h} of at least 99.5% after calcination in air at 1200° C. for 5 hours.

The composite oxide may for instance exhibit:
RD_{1000° C./5 h} of at least 95.0% after calcination at 1000° C. for 5 hours; and
RD_{950° C./5 h} of at least 94.0% after calcination at 950° C. for 5 hours.

The relative densities provided for the composite oxide are determined on a sample without the addition of any other material such as a sintering aid.

The relative density RD is well-known to the skilled person in the field of ceramics. It corresponds to the density of the composite oxide over the absolute density of the composite oxide expressed in % (RD in %=density/absolute density×100).

In the context of the invention, the density of the composite oxide is measured on a compacted sample of the composite oxide after calcination of the compacted sample in air at the temperature of the test (950° C., 1000° C., 1100° C. or 1200° C.) for 5 hours. The compacted sample is obtained by applying a pressure on the composite oxide in the powder form having been introduced into a molding die. Conveniently, the die has the form of a parallelepiped since this form allows an easy measurement of the volume after the calcination in air.

More specifically, the compacted sample may be prepared by the following method:
i) the powder of the composite oxide is weighed and introduced into a molding die;
ii) the powder is compressed under pressure;
iii) the compacted sample obtained at the end of step ii) is taken out from the molding die;
iv) the compacted sample is then calcined in air at the targeted temperature for 5 hours;
v) the density of the compacted sample having been calcined is measured;
vi) the relative density is then calculated.

The density is measured according to any of the experimental techniques known to the skilled person.

For step v), the following method may more particularly be used:
v1) the compacted sample having been calcined is weighed (weight in g);
v2) the volume of the compacted sample is measured (volume in cm³), the compacted sample being in the form of a parallelepiped and the volume of the parallelepiped is given by:

$$volume = length ( cm ) \times width ( cm ) \times height ( cm ) .$$

The length, width and height of the parallelepiped can be conveniently measured with a micrometer.

In step ii), the pressure applied to obtain the compacted sample is preferably at least 95 MPa or even at least 98 MPa.

The conditions of the test given in the examples may conveniently be used.

The absolute densities (or theoretical densities) are determined by first calculating the lattice parameters of the structure of the composite oxide from the XRD pattern and calculating the absolute density in accordance with the formula below:

$$absolute density ( g / {cm}^{3} ) = SA / ( a \times b \times c \times N )$$

SA represents the molar mass of all the atoms in the unit lattice, a, b and c each denotes the lattice parameter and N denotes the Avogadro's constant.

The following absolute densities used for the calculations are enclosed in the table below:

| Proportion | Absolute |
|---|---|
| of Gd (mol %) | density (g/cm³) |
| 8.0-10.0 | 7.22 |
| (value excluded) | |
| 10.0-22.0 | 7.21 |

### 2) Porosity and Pore Diameter Dp (Hg Porosity)

The process of the invention makes it possible to obtain a composite oxide with a specific distribution of the size of the pores. The composite oxide may exhibit in the range of pores with a diameter of less than or equal to 200 nm, a peak for which the maximum corresponds to a pore diameter Dp between 30 and 100 nm. Dp may also be between 30 and 70 nm. The pore diameter is obtained by mercury porosimetry.

Said peak usually exhibits a width at half height of the peak of less than 80 nm, more particularly less than 70 nm, even more particularly less than 60 nm, even more particularly less than 50 nm, even more particularly less than 40 nm, even more particularly less than 30 nm, even more particularly less than 20 nm.

The pore volume for the pores with a diameter lower and equal to 200 nm (Vp-200 nm) is generally lower than 0.40 mL/g, more particularly lower than 0.35 mL/g, even more particularly lower than 0.30 mL/g. Vp-200 nm is generally at least 0.10 mL/g.

Usually, the porogram exhibits a single peak in the range of pores with a diameter less than or equal to 200 nm.

### 3) BET Specific Surface Area

The composite oxide usually exhibits a BET specific surface area between 5 and 40 m²/g. The BET specific surface area may be between 10 and 35 m²/g or between 20 and 30 m²/g or between and 30 m²/g. The BET surface area is well-known to the skilled person. It is measured by nitrogen adsorption using the well-known Brunauer-Emmett-Teller method. The BET method is in particular described in the journal “The Journal of the American Chemical Society, 60, 309 (1938)”. It is possible to comply with the recommendations of the standard ASTM D3663-03.

### 4) Particle Size (by Laser Diffraction)

The composite oxide may also exhibit certain characteristics of size determined by a laser diffraction analyzer on a distribution of size (in volume).

D50 may be between 0.1 and 15.0 μm. D50 may more particularly be between 0.2 and 15 μm, even between 1.0 and 15.0 μm or between 5.0 and 15.0 μm.

D16 may be between 0.1 and 4.0 μm. D16 may more particularly be between 0.1 and 1.0 μm.

D84 may be between 10.0 and 50.0 μm. D84 may more particularly be between 15.0 and 50.0 μm.

The parameters D16, D84 and D50 are obtained from a distribution in volume determined by laser diffraction. D16 is the diameter determined from a distribution obtained by laser diffraction for which 16% of the particles have a diameter of less than D16. D84 is the diameter determined from a distribution obtained by laser diffraction for which 84% of the particles have a diameter of less than D84. D50 is the diameter determined from a distribution obtained by laser diffraction for which 50% of the particles have a diameter of less than D50. D50 is also denoted the median of the distribution.

The distribution may exhibit at least two populations. More particularly, the distribution may exhibit at least two populations P1 and P2 with the following characteristics:
population P1 centered at a diameter D1 lower than 3.0 μm and/or
population P2 centered at a diameter D2 greater than 8.0 μm.

In particular, in the domain of the diameters below 100 μm, the distribution may exhibit two populations P1 and P2 with the following characteristics:
population P1 centered at a diameter D1 lower than 3.0 μm and/or
population P2 centered at a diameter D2 greater than 8.0 μm.

The expression “population centered at a diameter D” means that on the distribution curve, a peak is observed the maximum of which is located at D.

D1 may more particularly be between 0.1 and 3.0 μm, even more particularly between 0.1 and 1.0 μm

D2 may more particularly be between 8.0 and 100 μm, more particularly between 10.0 and 100.0 μm, even more particularly between 10.0 and 70.0 μm, more particularly between 10.0 and 50.0 μm.

The two populations P1 and P2 may also be such that the ratio H2/H1 of the heights H1 and H2 of the two peaks respectively P1 and P2:
higher than 0.1, more particularly higher than 0.3, more particularly higher than 1.0, even more particularly higher than 1.5; or
lower than 7.0, more particularly lower than 5.5, even more particularly lower than 1.0, more particularly lower than 0.8, even more particularly lower than 0.5.

Ratio H2/H1 is usually between 0.1 and 7.0, more particularly between 0.1 and 5.5, even more particularly between 0.1 and 1.0. H2/H1 may also be between 0.1 and 0.8 or even between 0.1 and 0.5 or between 0.4 and 0.5

The ratio H2/H1 depends on the conditions of the process, in particular the concentration of solution S and the conditions of step e). The higher the concentration of solution S, the lower the ratio. The higher the duration and/or the intensity of the grinding step e) the lower the ratio.

The composite oxide is usually in the form of a powder.

### About the Process of Preparation of the Composite Oxide

The process of preparation of the composite oxide of the invention comprises the following steps:
a) an aqueous solution S comprising cerium nitrate (Cell) and gadolinium nitrate is added to an aqueous basic solution of ammonium hydrogen-carbonate (NH₄HCO₃) whereby a precipitate is formed;
b) an aqueous slurry containing the precipitate obtained at the end of step a) is heated at a temperature between 50° C. and 95° C.;
c) the solid obtained at the end of step b) is recovered and washed with water;
d) the solid recovered from step c) is calcined in air at a temperature between 600° C. and 1000° C.;
e) the calcined solid is ground.

### Step a)

In step a), two aqueous solutions are used: an aqueous basic solution of NH₄HCO₃ and an aqueous solution S comprising cerium nitrate (Ce^{III}) and gadolinium nitrate at the targeted proportion of Gd. The concentration of cerium nitrate in solution S is usually between 0.15 and 0.50 mol/L. The aqueous solution S comprises Ce^{III}, Gd^{III}, NO₃⁻ and H⁺. The concentration of cerium nitrate in solution S disclosed in example 1 or example 2 may conveniently be used.

Solution S is obtained by mixing two aqueous solutions of cerium nitrate and gadolinium nitrate and diluting with water the obtained conitrate solution. The volume of water used for the dilution may be between 5 and 10 times the volume of the conitrate solution. The ratio volume of water/volume of the conitrate solution may be as disclosed in example 1 or 2.

Each of the two solutions (Ce nitrate and Gd nitrate) used to prepare the conitrate solution may exhibit a residual acidity. The residual acidity may conveniently be measured by an acid/base titration with methyl orange as an indicator. The aqueous solution of cerium nitrate preferably exhibits a residual acidity which is lower than 0.1 mol/L, even lower than 0.07 mol/L. The aqueous solution of cerium nitrate used in the examples may conveniently be used. The aqueous solution of gadolinium nitrate preferably exhibits a residual acidity lower than 1.0 mol/L. The aqueous solution of cerium nitrate used in the examples may conveniently be used.

The aqueous basic solution of NH₄HCO₃ is prepared by dissolving in water NH₄HCO₃ in the solid form. The concentration of the aqueous aqueous basic solution of NH₄HCO₃ is preferably between 30 and 100 g/L. The concentrations disclosed in example 1 or example 2 may conveniently be used.

The aqueous solution S comprising cerium nitrate (Cell) and gadolinium nitrate is added to the aqueous basic solution of ammonium hydrogen-carbonate (NH₄HCO₃) whereby a precipitate is formed (this is usually disclosed as a “reverse precipitation”). The flow-rate of addition of the aqueous solution S which is added to the aqueous basic solution is usually between 50 and 200 L/h. Typically, the addition is performed for a duration between 20 and 120 minutes, more particularly between 20 and 60 minutes. The flow-rate and/or the duration used in one of the examples may conveniently be used.

The temperature at which step a) is performed is conveniently between 10° C. and 30° C.

The amount of hydrogenocarbonate used in step a) is such that the molar ratio r=NH₄HCO₃/(Ce+Gd) is between 3.00 and 3.48, more particularly between 3.10 and 3.45. The molar ratio r may conveniently be one of the molar ratios used in example 1 or 2.

The hydrogen-carbonate is used only in step a).

### Step b)

In step b), an aqueous slurry containing the precipitate obtained at the end of step a) is heated at a temperature between 50° C. and 95° C., more particularly between 70° C. and 95° C. This temperature may also be between 70° C. and 85° C. The temperature disclosed in example 1 or 2 (80° C.) may be conveniently used. The duration of the treatment may be between 1 and 4 hours.

The duration disclosed in example 1 or 2 (3 hours) may conveniently be used.

The aqueous slurry to be heated during step b) may be obtained according to two embodiments. According to a 1^{st} embodiment (preferred), the aqueous slurry is as obtained directly at the end of step a). This means that step a) and step b) may conveniently be performed in the same vessel.

According to a 2^{nd} embodiment, the aqueous slurry of step b) is obtained by dilution with water of the aqueous slurry as obtained at the end of step a).

### Step c)

In step c), the solid obtained at the end of step b) is recovered and washed with water, e.g. deionized water. It is possible to measure the conductivity of the filtrate. Usually the washing is performed until a conductivity of the filtrate lower than 5 mS/cm is reached.

### Step d)

In step d), the solid recovered from step c) is calcined in air at a temperature between 600° C. and 1000° C. The temperature of calcination is preferably between 750° C. and 850° C. The duration of step d) may be between 1 and 25 hours, more particularly between 1 and 20 hours. Under specific conditions, the temperature of calcination is 800° C. and the duration of the calcination at this temperature is 8 hours. The conditions of step d) of example 1 may apply. The calcination step aims at obtaining the conversion of cerium and gadolinium into oxides and at increasing the crystallinity of the composition.

### Step e)

The calcined solid obtained at the end of step d) is ground. A hammer mill may be used. The calcined solid may also be ground in a mortar.

The experimental details given in examples 1-3 could be followed for the preparation of a composite oxide according to the invention, notably in the range of proportions given as described herein.

### About the Use of the Composite Oxide

The composite oxide of the invention can be used in the preparation of a SOFC. In a SOFC, electricity is generated through the reaction between a fuel and an oxygen source. The oxygen source, typically air, contacts the cathode to form oxygen ions upon reduction by electrons at the cathode. The oxygen ions encounter the fuel at the anode forming water and carbon dioxide when the SOFC operates with an hydrocarbon fuel and electrons.

A SOFC comprises two porous electrodes (A) and (C) separated by at least one electrolyte layer (L). The composite oxide of the invention may be used as an oxygen-ion conducting material in the preparation of one or more of these three components, that is either the anode, the cathode or the at least one layer. Details will be now given about each of these three components of the SOFC. The invention thus also relates to a SOFC comprising one porous anode (A) and one porous cathode (C) which are separated by at least one layer (L) wherein at least one of the component (A), (C) or (L) is prepared from or comprises the composite oxide of the invention.

The function of the layer (L) is to act as a barrier to avoid the direct contact of the fuel and the source of oxygen. Another function of the barrier is to let the oxygen ions diffuse through the layer.

In the context of the invention, at least one component (A), (C) or (L) is prepared from or comprises the composite oxide of the invention.

### Anode (A)

The invention also relates to an anode comprising or prepared from the composite oxide of the invention and optionally at least one other inorganic material. The oxidation of the fuel takes place in the anode. The inorganic material other than the composite oxide used in the anode may be selected in the group consisting of a zirconia doped with at least one element selected in the group of Y, Sc, Ce and a combination of two or more of these three elements; a mixed oxide of cerium and gadolinium; a metal such as nickel; a lanthane titanate; and a lanthane chromite.

An example of lanthane titanate is for instance of formula La_{0.2}Sr_{0.25}Ca_{0.45} TiO₃.

### Cathode (C)

It also relates to a cathode comprising or prepared from the composite oxide of the invention and optionally at least one other inorganic material. The reduction of oxygen takes place in the cathode. The inorganic material other than the composite oxide used in the cathode may be selected in the group consisting of a zirconia doped with at least one element selected in the group of Y, Sc, Ce and a combination of two or more of these three elements; a mixed oxide of cerium and gadolinium; a mixed oxide of cerium and samarium; a La, Sr, Co and Fe-containing perovskite; and a La, Sr, Mn-containing perovskite.

The La, Sr, Co and Fe-containing perovskite may generally be described by generic formula LaₓSr₁₋ₓCo_{y}Fe_{1-y}O_{3{plus or minus}δ} wherein x and y are respectively numbers between 0.5 and 0.9 and between 0.1 and 0.9. For instance, x=0.8; y=0.8 or x=0.6 and y=0.2. Examples of such perovskites are disclosed in “Synthesis and Study of LSCF Perovskites for IT SOFC Cathode Application”, ECS Transactions, 2009, 25(2) (DOI: 10.1149/1.3205796).

The La, Sr, Mn-containing perovskite may generally be described by generic formula La₁₋ₓSrₓMnO₃ wherein x is a number between 0 and 1.0.

### Electrolyte Layer (L)

It also relates to a layer comprising or prepared from the composite oxide of the invention and optionally at least one other inorganic material. The inorganic material other than the composite oxide may be selected in the group consisting of zirconia doped with at least one element selected in the group of Y, Sc, Ce and a combination of two or more of these three elements or a mixed oxide of cerium and gadolinium.

The preparation of a SOFC may involve the composite oxide of the invention as disclosed in all its details before. The preparation may also involve the composite oxide of the invention that is modified by the addition of a sintering aid (see below) and/or by a mechanical treatment such as a grinding step.

Examples of SOFCs are now provided below. An example Ex1 of SOFC is based on the following configuration:
an anode (A);
a layer (L) comprising or prepared from the composite oxide of the invention and optionally further comprising at least one other inorganic material;
a cathode (C).

The SOFC of Ex1 may also comprise an additional layer (L1) between (L) and (C), the function of which is to prevent short-circuits. This additional layer (L1) typically comprises a zirconia doped with at least one element selected in the group of Y, Sc, Ce and a combination of two or more of these three elements. When the SOFC of Ex1 comprises the additional layer (L1), it may also comprise an additional layer (L2) between (L1) and (C) comprising or prepared from the composite oxide of the invention and/or a mixed oxide of cerium and gadolinium different from the composite oxide of the invention. This additional layer (L2) helps in preventing the diffusion of elements from the cathode (C) such as strontium to the additional layer (L1).

In Ex1, the anode (A) and/or the cathode (C) may comprise the composite of the invention and/or a mixed oxide of cerium and gadolinium different from the composite oxide of the invention.

Another example Ex2 of SOFC is based on the following configuration:
an anode (A);
a layer (L);
an additional layer (L2) comprising or prepared from the composite oxide of the invention and optionally further comprising at least one other inorganic material;
a cathode (C).

Layer (L) typically comprises a zirconia doped with at least one element selected in the group of Y, Sc, Ce and a combination of two or more of these three elements.

In Ex2, the anode (A) and/or the cathode (C) may comprise or be prepared from the composite of the invention and/or a mixed oxide of cerium and gadolinium different from the composite oxide of the invention.

The composite oxide of the invention may be used in the preparation of a cell as disclosed in one of the following documents by replacing the cerium-gadolinium disclosed therein by the composite oxide of the invention: WO 02/35628; WO 03/075382; WO 2004/089848; WO 2005/078843; WO 2006/079800; WO 2006/106334; WO 2007/085863; WO 2007/110587; WO 2008/001119; WO 2008/003976; WO 2008/015461; WO 2008/053213; WO 2008/104760; WO 2008/132493; US 2013/0052562; WO 2021/151692; WO 2016/124929; WO 2015/033104; WO 2017/153751; WO 2021/096828; U.S. Pat. No. 8,435,694 B2; U.S. Pat. No. 10,749,188 B2; US 2008/254336; DE 102013007 637; US 2013/0095408. The composite oxide of the invention may also be used in the preparation of a cell as disclosed in the PHD thesis of Clément Nicollet (“Nouvelles électrodes à oxygène pour SOFC à base de nickelates Ln₂NiO_{4+δ} (Ln=La, Pr) préparées par infiltration”).

The layers of the SOFC and the SOFC are prepared by known methods:
casting methods (ex: tape or slip casting) for thicknesses between 100 μm up to mm scale (typically <800 μm and <300 μm) for support layers (electrolyte or anode);
printing methods (ex: screen, inkjet printing), spraying, lamination, spin coating for thin layers (typically <50 μm);
in addition to printing methods, for ultra-thin layers L1 and L2 (typically <5 μm), sputtering methods (ex: magnetron or gas flow), physical vapor deposition, Atomic Layer Deposition, Pulsed Laser Deposition;
for tubular design cells: dip coating or injection molding may be used.

The skilled person can also find a relevant teaching of preparation in the above-mentioned thesis.

The methods disclosed in one of the documents disclosed above may also be used.

The composite oxide of the invention can also be used in the preparation of a solid-oxide electrolyzer cell (SOEC). A SOEC makes it possible to produce green hydrogen by high temperature electrolysis (typically 700-800° C.). Examples of SOECs are provided in Renewable and Sustainable Energy Reviews Volume 149, October 2021, 111322 (“Alternative and innovative solid oxide electrolysis cell materials: A short review”) or in the article of Pysik et al. referenced by https://doi.org/10.1002/fuce.201900245 (“Long-Term Behavior of a Solid Oxide Electrolyzer (SOEC) Stack”).

The configuration of a SOEC is quite similar to the one of a SOFC; a SOEC may thus comprise:
an anode (A*);
a layer (L) comprising or prepared from the composite oxide of the invention and/or a mixed oxide of cerium and gadolinium different from the composite oxide of the invention and optionally further comprising at least one other inorganic material;
a cathode (C*).

The precisions provided above for the anode (A*) and cathode (C*) must however be taken from the precisions of respectively the cathode (C) and the anode (A) because a SOEC functions in a reverse mode compared to a SOFC. To be clear, all what is disclosed above for the SOFC remains valid for the SOEC with the following precisions: anode (A)⇒cathode (C*) and cathode (C)⇒anode (A*). For instance, an example of SOEC is according to the following configuration:
a cathode (C*);
a layer (L);
an additional layer (L1) comprising the composite oxide of the invention and optionally further comprising at least one other inorganic material;

an anode (A*).

The composite oxide of the invention may be used in the preparation of a cell as disclosed in one of the following documents by replacing the cerium-gadolinium disclosed therein by the composite oxide of the invention: KR 102305294 B1; CN 113445061; EP 3793012.

### Composition C Comprising the Composite Oxide of the Invention

In the context of the invention, the composite oxide already exhibits a high relative density at a temperature as “low” as 950° C. Yet, a sintering aid may be added to the composite oxide with a view of further improving its sinterability. Therefore, the invention also relates to a composition C comprising the composite oxide of the invention and further comprising at least one sintering aid.

The sintering aid may for instance be an element E selected in the group of Zn, the transition metal elements, the rare-earth elements or the alkali metals. E may more particularly be selected in the group of the transition elements. E may for instance be selected in the group consisting of Li, Zn, Cu, Co, Fe, Mn, Ni and the combinations thereof. The element E may be added in the form of a salt, such as an acetate or a nitrate. Element E may be present in the composition in the form of an oxide.

The proportion of the sintering aid in the composition C may be between 0.1 and 5.0 wt %. The proportion may be higher than 0.5 wt %. It may be lower than 3.0 wt %.

Composition C may be prepared by the method comprising the following steps: (i) putting into contact the composite oxide of the invention and a salt of element E or a precursor of the oxide of element E, (ii) removing the solution, (iii) drying the solid and (iv) optionally calcining in air. Step (i) may be performed in a liquid medium such as water or an alcohol. A salt of element (E) may for instance be a nitrate or an acetate. A precursor of the oxide of element (E) may for instance be an acetylacetonate.

Composition C may be in the powder form. All characteristics disclosed in 1) to 4) are still applicable for the composition C.

Composition C may be used in the preparation of a SOFC or SOEC. All what is disclosed above for the SOFC or SOEC remains valid by replacing the composite oxide of the invention by composition C comprising the composite oxide of the invention and the sintering aid.

### EXAMPLES

The skilled person will implement the invention as disclosed above and in the claims with the help of and in view of the examples given below.

In the examples below, use is made of cerium (III) nitrate and gadolinium nitrate, both obtained by direct attack of the corresponding oxide with nitric acid. The aqueous solution of cerium nitrate used to prepare the conitrate solution exhibits a residual acidity which is 0.05 mol/L. The aqueous solution of gadolinium nitrate used to prepare the conitrate solution exhibits a residual acidity of 0.60 mol/L. Residual acidity was measured by acid-base titration.

The basic solutions used were prepared before each example by dissolving NH₄HCO₃ (Nissan Chemical) in water. In the examples 1-3 below, the reactor used is a 200 liter reactor equipped with a stirrer.

### Measurement of D16, D50 and D84

The particle size distributions were obtained with a laser diffraction analyzer HORIBA, Ltd., LA-920. The particles are dispersed in water with 0.2 wt % of hexametaphosphate. A refractive index of 1.20 was used.

### BET Specific Surface Areas

The BET specific surface areas were measured with a MOUNTECH Co., Ltd., Macsorb HM model-1220 after desorption of the adsorbed species at 210° C. for 30 min.

### Hg Porosity

The porosity was obtained with an autopore IV 9500 Automatic Mercury Porosimeter following the guidelines of the constructor and after a pretreatment at 210° C. for 30 min. The sample size was around 0.2 grams, the mercury contact angle was 130°, the mercury surface tension was 485 dyn/cm.

X-Ray Diffraction Use was made of an x-ray diffractometer Ultima IV with a copper source (CuKα1, λ=1.5406 Angstrom).

### Measurement of the Density and of the Relative Density

The following method was used and may be used in the context of the invention:

```
i) the powder of the composite oxide is weighed and introduced into a molding die;
ii) the powder is compressed under pressure;
iii) the compacted sample obtained at the end of step ii) is taken out from the molding die;
iv) the compacted sample is then calcined in air at the targeted temperature for 5 hours;
v) the density of the compacted sample having been calcined is measured with the
following steps:
  v1) the compacted sample having been calcined is weighed (weight in g);
  v2) the volume of the compacted sample is measured (volume in cm³), the compacted
  sample being in the form of a parallelepiped and the volume of the parallelepiped is
  given by:
```

volume = length (cm) × width (cm) × height (cm);

vi) the relative density is then calculated.

The specific conditions used were the following:
in step i), dimensions of the rectangular shape: 23×7 mm;
the amount of powder used: about 1 g;
in step ii), the powder is compressed under an uniaxial pressing to obtain the compacted sample.

The strength applied during the pressing is 15.8 kN. This corresponds to a pressure of 98 MPa.

### Example 1: Preparation of a Composite Oxide with 10% Gd-Cerium Nitrate 0.27 Mol/L and Gadolinium Nitrate 0.03 Mol/L; Total Concentration 0.3 Mol/L

step a): the aqueous solution of cerium (III) nitrate (ca. 3 mol/L) and the aqueous solution of gadolinium nitrate (ca. 2 mol/L) were mixed at a ratio corresponding to CeO₂: GdO_{1.5}=90:10 (molar ratio), to prepare a conitrate solution. This conitrate solution (equivalent to 2.6 kg of composite oxide) was diluted with deionized water to prepare the starting solution S (cerium nitrate 0.27 mol/L and gadolinium nitrate 0.03 mol/L; total concentration 0.3 mol/L).

The starting solution S was added at a constant flow rate over a period of 30 minutes to 80.0 L of an aqueous solution of ammonium hydrogen carbonate (48.8 g/L) under stirring at 25° C. by which a precipitate containing cerium and gadolinium was obtained. The pH of the slurry is 6.9.
step b): the slurry obtained at the end of step a) was heat-treated at 80° C. for 3 hours in a reactor equipped with air flushing above the level of liquid. The slurry is left cool down to room temperature. The pH of the slurry is 8.1.
step c): the slurry obtained at the end of step b) was filtrated and washed several times using deionized water until a conductivity of the filtrate is lower than 5 mS/cm.
step d): the cake obtained at the end of step c) was heated in a furnace under air with ramp of 1.6° C./min to reach 800° C., and kept at 800° C. for 8 hours. After that, the solid was cooled naturally in the oven.
step e): the calcined solid was ground in a hammer mill, to thereby obtain the composite oxide Ce_{0.9}Gd_{0.1}O_{2-δ} in the form of a powder with D84<50 μm.

### Example 2: Preparation of a Composite Oxide with 10% Gd-Cerium Nitrate 0.36 Mol/L and Gadolinium Nitrate 0.04 Mol/L; Total Concentration 0.4 Mol/L

step a): an aqueous solution of cerium (III) nitrate (ca. 3 mol/L) and an aqueous solution of gadolinium nitrate (ca. 2 mol/L) were mixed at a ratio corresponding to CeO₂: GdO_{1.5}=90:10 (molar ratio), to prepare a mixed solution. This mixed solution (equivalent to 5.2 kg of composite oxide) was diluted with deionized water to prepare the starting solution S (cerium nitrate 0.36 mol/L and gadolinium nitrate 0.04 mol/L; total concentration 0.4 mol/L).

The starting solution S was added at a constant flow rate over a period of 45 minutes to 107.0 L of an aqueous solution of ammonium hydrogen carbonate (72.9 g/L) under stirring at 25° C. by which a precipitate slurry containing cerium and gadolinium was obtained. The pH reached is 6.6.
step b): the slurry obtained at the end of step a) was heat-treated at 80° C. for 3 hours in a reactor equipped with air flushing above the level of liquid. The slurry is let cool down to room temperature. The pH reached is 7.9.
step c): the slurry obtained at the end of step b) was filtrated and washed several times using deionized water until a conductivity of the filtrate is lower than 5 mS/cm.
step d): the obtained precipitate was heated in a furnace under air with ramp of 1.6° C./min to reach 800° C., and kept at 800° C. for 8 hours. After that, the solid was cooled naturally in the oven.
step e): the calcined solid was ground in a hammer mill, to thereby obtain Ce_{0.9}Gd_{0.1}O_{2-δ} in the form of a powder with D84<50 μm.

### Example 3: Preparation of a Composite Oxide with 20% Gd

A composite oxide with 20% Gd was prepared following the same method as example 1 with a molar ratio r of 3.30. Conitrate solution: CeO₂: GdO_{1.5}=80:20 (molar ratio).

### Comparative Example 1: Preparation of a Composite Oxide with 10% Gd-According to the Recipe Disclosed in Example 1 of EP 1484282 B1-Cerium Nitrate 0.27 Mol/L and Gadolinium Nitrate 0.03 Mol/L; Total Concentration 0.3 Mol/L

An aqueous solution of cerium nitrate (ca.3 mol/L) and an aqueous solution of gadolinium nitrate (ca.2 mol/L) were mixed at a ratio of CeO₂:GdO_{1.5}=90:10 (molar ratio), to prepare a mixed solution. This solution (equivalent to 20 g of composite oxide) was diluted with deionized water to prepare a 0.3 mol/L starting solution.

0.4 L of a prepared 75 g/L aqueous solution of ammonium hydrogen-carbonate was added to the starting solution under stirring at 25° C. to prepare a precipitate. To the slurry, 20 ml of 100 g/L aqueous solution of ammonium hydrogen carbonate was further added. The pH of the slurry is 7.9. The slurry was heat-treated in a flask equipped with a reflux condenser under atmospheric pressure at 100° C. for 3 hours. Then filtration and washing were repeated 10 times using deionized water an the conductivity of the filtrate was 0.67 mS/cm. The obtained precipitate was calcined in a furnace under air at 700° C. for 5 hours, and ground in a mortar, to thereby obtain 20 g of Ce_{0.9}Gd_{0.1}O_{2-δ} in the powder form.

The composition of the obtained powders was confirmed using an ICP emission spectrophotometer (HITACHI High-Tech Corporation, Inductivity Coupled Plasma Optical Emission Spectrometer, PS-3500DD).

TABLE I

| | | | | | | Hg | | |
|---|---|---|---|---|---|---|---|---|
| | Molar | | | | | porosity | | |
| | ratio r | | | | | Dp (nm) | Distribution of sizes (volume distribution) | |
| | (as | Relative densities (%) | | | | WHH (nm) | | D1 (μm) |
| | defined | | | 1100° C./5 h | BET | V_{p<200 nm} | | D2 (μm) |
| ex. | before) | 950° C./5 h | 1000° C./5 h | 1200° C./5 h | (m²/g) | (mL/g) | D16; D50; D84 (μm) | H2/H1 |
| 1 | 3.29 | 95.7% | 96.5% | 99.9% | 30 | 37.3 | 0.39; 8.99; 19.0 | 0.34 |
| | | | | / | | 18 | | 17.4 |
| | | | | | | 0.25 | | 2.0 |
| 2 | 3.29 | 94.2% | 95.7% | 99.7% | 25 | 53 | 0.16; 0.29; 15.1 | 0.20 |
| | | | | 99.9% | | 33 | | 17.4 |
| | | | | | | 0.27 | | 0.4 |
| 3 | 3.30 | 94.1% | 95.4% | / | 30 | / | 3.25; 12.9; 25.1 | 0.34 |
| | | | | | | | | 19.9 |
| | | | | | | | | 5.1 |
| comp. | 3.50 | — | 94.5% | 97.5% | 14 | / | 0.16; 0.22; 0.31 | 0.26 |
| ex. 1 | | | | 99.2% | | | | Not applicable |
| | | | | | | | | Not applicable |

WHH: width at half height;
Not applicable for comp. ex. 1: there is no second peak

1. A composite oxide based on cerium and gadolinium with a proportion of Gd between 8.0 and 22.0 mol %, this proportion corresponding to the molar ratio Gd/(Ce+Gd) expressed in %.

2. (canceled)

3. (canceled)

4. The composite oxide according to claim 1 wherein the X-ray diffractogram (CuKα1, λ=1.5406 Angstrom) of the composite oxide exhibits the patterns of a solid solution and/or a peak P at 2θ between 27.0 and 30.0°.

5. (canceled)

6. (canceled)

7. The composite oxide according to claim 1, exhibiting a relative density RD_{1000° C./5 h} after calcination in air of a compacted sample at 1000° C. for 5 hours of at least 95.0%, preferably at least 96.0% and/or of at most 99.0 or at most 98.0%.

8. (canceled)

9. (canceled)

10. The composite oxide according to claim 7, exhibiting a relative density RD_{950° C./5 h} after calcination in air of a compacted sample at 950° C. for 5 hours of at least 94.0%, preferably of at least 95.0% and/or of at most 98.0% or most 92.0%.

11. (canceled)

12. The composite oxide according to claim 7, exhibiting a relative density RD_{1100° C./5 h} after calcination in air of a compacted sample at 1100° C. for 5 hours of at least 99.0%, preferably at least 99.5%, and/or of at most 99.5% or at most 99.9%.

13. (canceled)

14. The composite oxide according to claim 7, exhibiting a relative density RD_{1200° C./5 h} after calcination in air of a compacted sample at 1200° C. for 5 hours of at least 99.5%.

15. The composite oxide according to claim 7, wherein the relative density is given by formula: RD in %=density/absolute density×100 where the density is measured on a compacted sample of the composite oxide after calcination for 5 hours of the compacted sample in air at the temperature of the test (950° C., 1000° C., 1100° C. or 1200° C.) and the absolute density is given in the table below:

| Proportion of Gd (mol %) | Absolute density (g/cm³) |
|---|---|
| 8.0-10.0 (value excluded) | 7.22 |
| 10.0-22.0 | 7.21 |

16. (canceled)

17. (canceled)

18. (canceled)

19. (canceled)

20. (canceled)

21. The composite oxide according to claim 7, exhibiting in the range of pores with a diameter of less than or equal to 200 nm, a peak for which the maximum corresponds to a pore diameter Dp between 30 and 100 nm, more particularly between 30 and 70 nm, Dp being determined by mercury porosimetry.

22. (canceled)

23. (canceled)

24. (canceled)

25. The composite oxide according to claim 7, exhibiting a pore volume for the pores with a diameter lower and equal to 200 nm (Vp_{<200 nm}) higher-than 0.10 mL/g, this pore volume being determined by Hg porosimetry.

26. The composite oxide according to claim 7, exhibiting a BET specific surface area between 5 and 40 m²/g preferably between 10 and 35 m²/g or between 25 and 30 m²/g or between 25 and 30 m²/g.

27. (canceled)

28. The composite oxide according to claim 7, wherein the distribution in volume of the size of the particles obtained by laser diffraction exhibits two populations P1 and P2 with the following characteristics:
population P1 centered at a size D1 lower than 3.0 μm and/or
population P2 centered at a size D2 greater than 8.0 μm;
the expression “population centered at a size D” meaning that on the distribution curve, a peak is observed the maximum of which is located at D.

29. The composite oxide according to claim 28, wherein in the domain of the diameters below 100 μm, the distribution exhibits two populations P1 and P2 with the following characteristics:
population P1 centered at a diameter D1 lower than 3.0 μm and/or
population P2 centered at a diameter D2 greater than 8.0 μm.

30. (canceled)

31. (canceled)

32. (canceled)

33. (canceled)

34. (canceled)

35. (canceled)

36. The composite oxide according to claim 28, wherein the ratio H2/H1 of the heights H1 and H2 of the two peaks respectively P1 and P2 is:
higher than 0.1; or
higher than 0.3; or
higher than 1.0; or
higher than 1.5,
and/or
lower than 7.0; or
lower than 5.5; or
lower than 1.0; or
lower than 0.8; or
lower than 0.5.

37. (canceled)

38. (canceled)

39. The composite oxide according to claim 1, wherein D50 is between 0.1 and 15.0 μm, D50 corresponding to the median of a distribution in volume of the size of the particles obtained by laser diffraction.

40. (canceled)

41. (canceled)

42. The composition C comprising a composite oxide according to claim 1 and a sintering aid wherein the sintering aid is preferably an element E selected in the group consisting of Li, Zn, Cu, Co, Fe, Mn, Ni and the combinations thereof and wherein the sintering aid is preferably in the form of an oxide.

43. (canceled)

44. (canceled)

45. (canceled)

46. (canceled)

47. A use of a composite oxide as defined in claim 1 for the preparation of a SOEC or of a SOFC.

48. (canceled)

49. A process of preparation of a composite oxide as defined in claim 1, comprising the following steps
a) an aqueous solution S comprising cerium nitrate (Cell) and gadolinium nitrate is added to an aqueous basic solution of ammonium hydrogen-carbonate (NH₄HCO₃) whereby a precipitate is formed;
b) an aqueous slurry containing the precipitate obtained at the end of step a) is heated at a temperature between 50° C. and 95° C.;
c) the precipitate is recovered at the end of step b) and washed with water;
d) the solid recovered from step c) is calcined in air at a temperature between 600° C. and 1000° C.;
e) the calcined solid is ground.

50. The process according to claim 49, wherein the molar ratio r=NH₄HCO₃/Ce+Gd is between 3.00 and 3.48, more particularly between 3.10 and 3.45.

51. A SOFC comprising one porous anode (A) and one porous cathode (C) which are separated by at least one layer (L) wherein at least one of the component (A), (C) or (L) is prepared from or comprises the composite oxide according to claim 1.

52. (canceled)

53. A SOEC comprising one porous anode (A*) and one porous cathode (C*) which are separated by at least one layer (L) wherein at least one of the component (A*), (C*) or (L) which is prepared from or comprises the composite oxide according to claim 1.
